(19) United States
(12) Patent Application Publication
(10) Pub. No.: US 2023/0267705 A1
(43) Pub. Date: Aug. 24, 2023

(54) INFORMATION PROCESSING SYSTEM AND INFERENCE METHOD

(71) Applicant: Fujitsu Limited, Kawasaki-shi (JP)

(72) Inventors: Takanori NAKAO, Kawasaki (JP); Xuying LEI, Kawasaki (JP)

(73) Assignee: Fujitsu Limited, Kawasaki-shi (JP)

(21) Appl. No.: 17/990,766

(22) Filed: Nov. 21, 2022

(30) Foreign Application Priority Data
Feb. 21, 2022 (JP) 2022-024809

(51) Int. Cl. G06V 10/771; G06T 7/73; G06V 10/25; G06V 10/77

(52) U.S. Cl. CPC G06V 10/771; G06T 7/74; G06V 10/25; G06V 10/7715; G06T 2207/20081

(57) ABSTRACT

An information processing system includes an edge computer that implements a preceding stage of a learning model, and a cloud computer that implements a subsequent stage of the learning model, wherein the edge computer includes a first processor configured to calculate a first feature amount by inputting a first image to the preceding stage, identify an area of interest in the first image based on the first feature amount, generate a second image obtained by masking the area of interest in the first image, calculate a second feature amount by inputting the second image to the preceding stage, and transmit the second feature amount to the cloud computer, and the cloud computer includes a second processor configured to infer an object included in the second image by inputting the second feature amount to the subsequent stage.

### CROSS-REFERENCE TO RELATED APPLICATION

This application is based upon and claims the benefit of priority of the prior Japanese Patent Application No. 2022-024809, filed on Feb. 21, 2022, the entire contents of which are incorporated herein by reference.

### FIELD

The embodiment discussed herein is related to an information processing system and an inference method.

### BACKGROUND

There is a technology in which a type and a position of an object included in video information are estimated by inputting the video information into a trained learning model. For example, the learning model includes a convolutional layer, a pooling layer, a fully connected layer, and the like.

FIG. 10 is a diagram illustrating an example of an existing learning model. In the example illustrated in FIG. 10, a learning model 5 includes convolutional layers 20a, 21a, 22a, 23a, 24a, and 25, pooling layers 20b, 21b, 22b, 23b, and 24b, and fully connected layers 26 and 27.

For example, when an input image 10 corresponding to video information is input to the convolutional layer 20a, a feature map 11 is output via the convolutional layer 20a and the pooling layer 20b. The feature map 11 is input to the convolutional layer 21a, and a feature map 12 is output via the convolutional layer 21a and the pooling layer 21b.

The feature map 12 is input to the convolutional layer 22a, and a feature map 13 is output via the convolutional layer 22a and the pooling layer 22b. The feature map 13 is input to the convolutional layer 23a, and a feature map 14 is output via the convolutional layer 23a and the pooling layer 23b. The feature map 14 is input to the convolutional layer 24a, and a feature map 15 is output via the convolutional layer 24a and the pooling layer 24b.

The feature map 15 is input to the convolutional layer 25, and a feature map 16 is output via the convolutional layer 25. The feature map 16 is input to the fully connected layer 26, and a feature map 17 is output via the fully connected layer 26. The feature map 17 is input to the fully connected layer 27, and output information 18 is output via the fully connected layer 27. The output information 18 includes an estimation result of a type and a position of an object included in the input image 10.

Here, there is a technology in which, in an edge-cloud environment, the learning model 5 is divided into a preceding stage and a subsequent stage, and processing of the preceding stage is executed by an edge, and processing of the subsequent stage is executed by a cloud. FIG. 11 is a diagram illustrating the existing technology. In the example illustrated in FIG. 11, the convolutional layers 20a, 21a, 22a, and 23a and the pooling layers 20b, 21b, 22b, and 23b are arranged on an edge 30A. The convolutional layers 24a and 25, the pooling layer 24b, and the fully connected layers 26 and 27 are arranged on a cloud 30B.

When the input image 10 is input, by using the convolutional layers 20a, 21a, 22a, and 23a and the pooling layers 20b, 21b, 22b, and 23b, the edge 30A generates the feature map 14 (feature amount), and transmits the feature map 14 to the cloud 30B. When the feature map 14 is received, by using the convolutional layers 24a and 25, the pooling layer 24b, and the fully connected layers 26 and 27, the cloud 30B outputs the output information 18.

As illustrated in FIG. 11, by dividing the learning model 5 to perform processing, it is possible to distribute a load and reduce a communication amount between the edge 30A and the cloud 30B. Furthermore, instead of transmitting the input image 10 (video information) directly to the cloud 30B, the feature amount (for example, the feature map 14) is transmitted. Thus, there is an advantage that content of the video information may concealed.

Japanese Laid-open Patent Publication No. 2019-40593 and U.S. Patent Application Publication No. 2020/252217 are disclosed as related art.

### SUMMARY

According to an aspect of the embodiment, an information processing system includes an edge computer that implements a plurality of layers of a preceding stage among a plurality of layers included in a learning model, and a cloud computer that implements a plurality of layers of a subsequent stage obtained by removing the plurality of layers of the preceding stage from the plurality of layers included in the learning model, wherein the edge computer includes a first processor configured to calculate a first feature amount by inputting a first image to a top layer among the plurality of layers of the preceding stage, identify an area of interest in the first image based on the first feature amount, generate a second image obtained by masking the area of interest in the first image, calculate a second feature amount by inputting the second image to the top layer among the plurality of layers of the preceding stage, and transmit the second feature amount to the cloud computer, and the cloud computer includes a second processor configured to infer an object included in the second image by inputting the second feature amount to a top layer among the plurality of layers of the subsequent stage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing system according to an embodiment;

FIG. 2 is a diagram illustrating a score of an inference result of an input image and scores of inference results of corrected images;

FIG. 3 is a diagram illustrating a functional configuration of an edge node according to the embodiment;

FIG. 4 is a diagram illustrating an example of first feature amount data;

FIG. 5 is a diagram illustrating a functional configuration of a cloud according to the embodiment;

FIG. 6 is a flowchart illustrating a processing procedure of the edge node according to the embodiment;

FIG. 7 is a flowchart illustrating a processing procedure of the cloud according to the embodiment;

FIG. 8 is a diagram illustrating an example of a hardware configuration of a computer that implements functions similar to those of the edge node of the embodiment;

FIG. 9 is a diagram illustrating an example of a hardware configuration of a computer that implements functions similar to those of the cloud of the embodiment;

FIG. 10 is a diagram illustrating an example of an existing learning model;

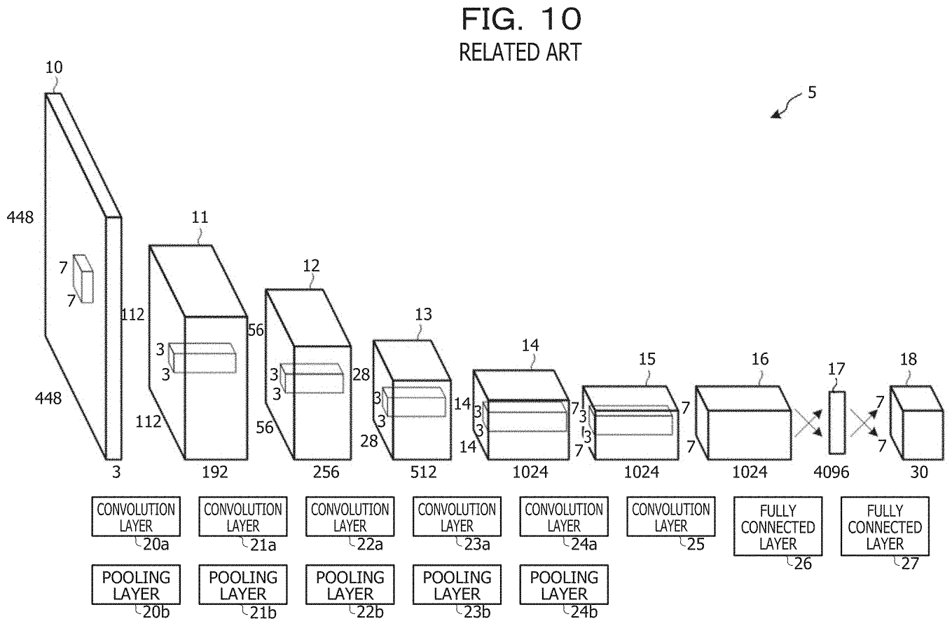

FIG. 11 is a diagram illustrating related art; and

FIG. 12 is a diagram illustrating a problem of related art.

### DESCRIPTION OF EMBODIMENT

The existing technology described above has a problem that it is not possible to maintain privacy for a characteristic area of an original image.

For example, in a case where the feature amount is analyzed on a side of the cloud 30B, the original image may be restored to some extent. Since the feature amount indicates a greater value in an area in which a feature of an object desired to be detected appears, a contour or the like of the object to be detected may be restored.

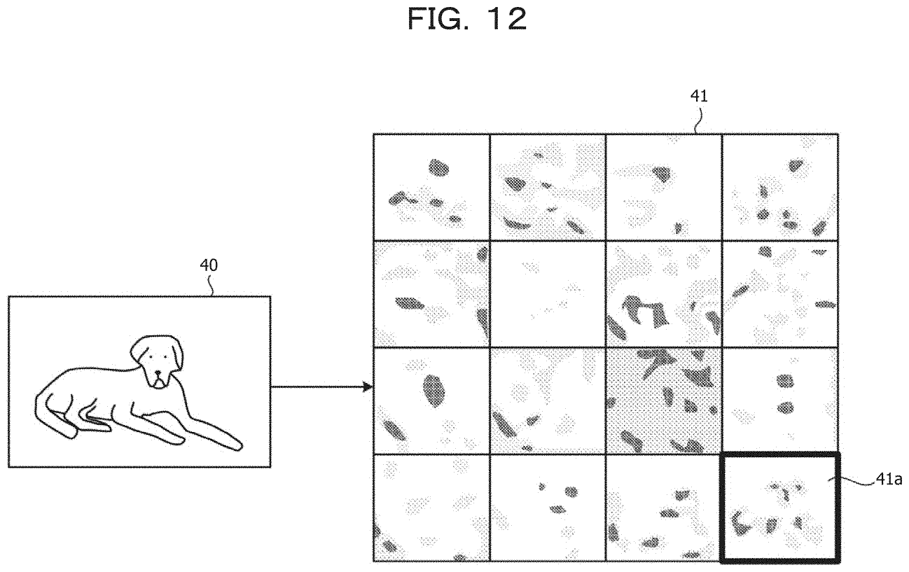

FIG. 12 is a diagram illustrating the problem of the existing technology. For example, by inputting input data 40 to the edge 30A, a feature map 41 is generated, and the feature map 41 is transmitted to the cloud 30B. Here, a contour of an object (for example, a dog) included in the input data 40 remains in an area 41a of the feature map 41, and there is a possibility that the contour or the like of the object may be restored.

Hereinafter, an embodiment of an information processing system and an inference method disclosed in the present application will be described in detail with reference to the drawings. Note that the embodiment does not limit the present disclosure.

### Embodiment

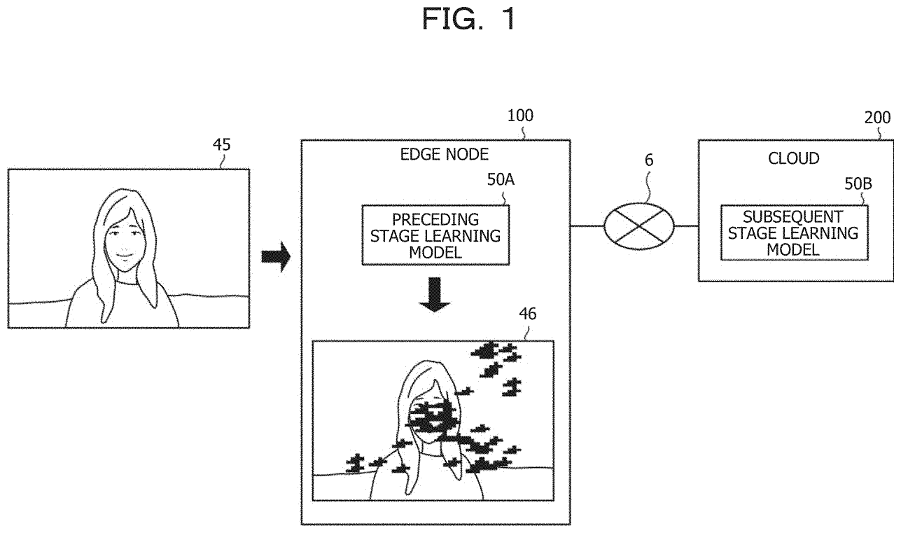

FIG. 1 is a diagram illustrating an example of the information processing system according to the present embodiment. As illustrated in FIG. 1, the information processing system includes an edge node 100 and a cloud 200. The edge node 100 and the cloud 200 are mutually coupled via a network 6.

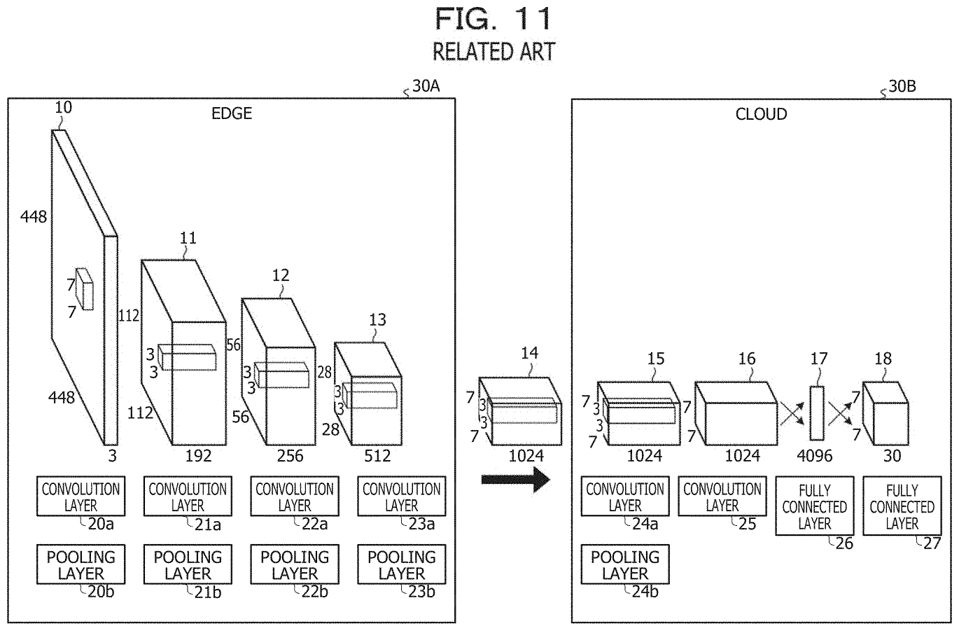

The edge node 100 includes a preceding stage learning model 50A that performs inference of a preceding stage of a trained learning model. For example, the preceding stage learning model 50A includes layers corresponding to the convolutional layers 20a, 21a, 22a, and 23a and the pooling layers 20b, 21b, 22b, and 23b described with reference to FIG. 11.

The cloud 200 includes a subsequent stage learning model 50B that performs inference of a subsequent stage of the trained learning model. For example, the subsequent stage learning model 50B includes layers corresponding to the convolutional layers 24a and 25, the pooling layer 24b, and the fully connected layers 26 and 27 described with reference to FIG. 11. The cloud 200 may be a single server device, or a plurality of server devices that may function as the cloud 200 by sharing processing.

With reference to FIG. 1, processing of the information processing system will be described. When input of an input image 45 is received, the edge node 100 inputs the input image 45 to the preceding stage learning model 50A, and calculates a first feature amount. The edge node 100 identifies an area of interest in the input image 45 based on the first feature amount.

The edge node 100 blackens the area of interest in the input image 45 to generate a corrected image 46. By inputting the corrected image 46 to the preceding stage learning model 50A, the edge node 100 calculates a second feature amount. The edge node 100 transmits the second feature amount of the corrected image 46 to the cloud 200 via the network 6.

When the second feature amount is received from the edge node 100, the cloud 200 generates output information by inputting the second feature amount to the subsequent stage learning model 50B. For example, the output information includes a type, a position, and a score (likelihood) of an object included in the corrected image 46.

As described above, in the information processing system according to the present embodiment, in a case where inference of the input image 45 is performed, the edge node 100 identifies the area of interest of the input image 45 based on the first feature amount obtained by inputting the input image 45 to the preceding stage learning model 50A. The edge node 100 generates the corrected image 46 by masking the area of interest of the input image 45, and transmits, to the cloud 200, the second feature amount obtained by inputting the corrected image 46 to the preceding stage learning model 50A. The cloud 200 performs inference by inputting the received second feature amount to the subsequent stage learning model 50B.

Here, since the corrected image 46 is an image obtained by masking a characteristic portion of the input image 45, the corrected image 46 does not include important information in terms of privacy. Therefore, by transmitting the second feature amount of the corrected image 46 to the cloud 200, it is possible to maintain the privacy for the characteristic area of the original image.

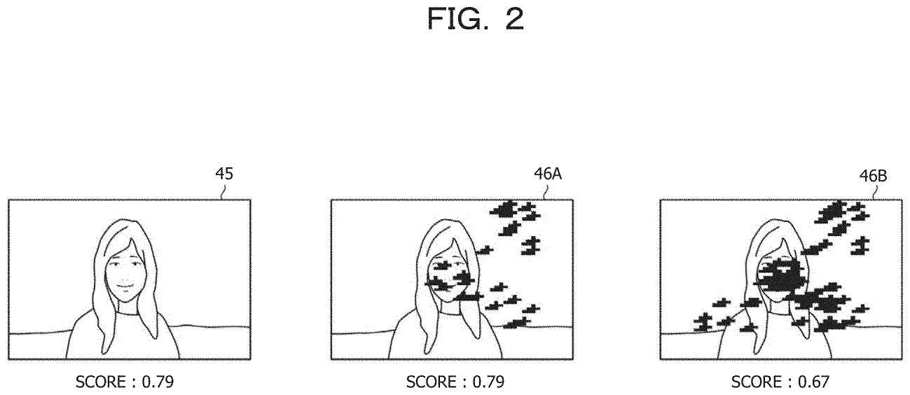

Moreover, even when the second feature amount of the corrected image 46 is transmitted to the cloud 200 and inference is executed, the inference may be executed with high accuracy. FIG. 2 is a diagram illustrating a score of an inference result of the input image and scores of inference results of corrected images. In FIG. 2, scores of the input image 45 and inference results of corrected images 46A and 46B are indicated. The score of the inference result is likelihood corresponding to an identification result of an object, and is output from the subsequent stage learning model 50B. Note that, it is assumed that the score of the inference result of the input image 45 is a score in a case where the first feature amount is transmitted to the cloud 200 as it is and inference is performed. The corrected image 46B has a greater ratio of blackened (masked) portions than the corrected image 46A. Compared with the score “0.79” of the input image 45, the score of the corrected image 46A is “0.79” and the score of the corrected image 46B is “0.67”, so that an object may be accurately discriminated even when blackening is performed to some extent.

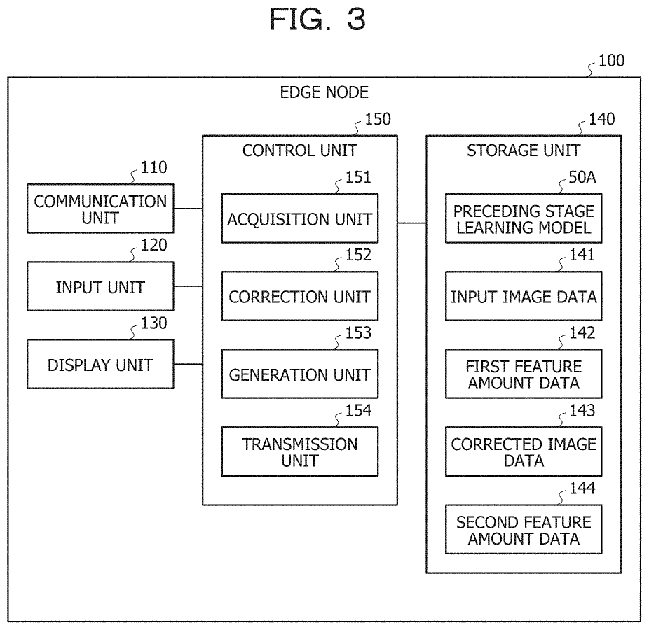

Next, a configuration example of the edge node 100 illustrated in FIG. 1 will be described. FIG. 3 is a diagram illustrating a functional configuration of the edge node 100 according to the present embodiment. As illustrated in FIG. 3, the edge node 100 includes a communication unit 110, an input unit 120, a display unit 130, a storage unit 140, and a control unit 150.

The communication unit 110 executes data communication with the cloud 200 or another external device via the network 6. For example, the edge node 100 may acquire data of an input image from an external device.

The input unit 120 is an input device that receives an operation from a user, and is implemented by, for example, a keyboard, a mouse, a scanner, or the like.

The display unit 130 is a display device for outputting various types of information, and is implemented by, for example, a liquid crystal monitor, a printer, or the like.

The storage unit 140 is a storage device that stores various types of information, and is implemented by, for example, a semiconductor memory element such as a random access memory (RAM) or a flash memory, or a storage device such as a hard disk or an optical disk. The storage unit 140 includes the preceding stage learning model 50A, input image data 141, first feature amount data 142, corrected image data 143, and second feature amount data 144.

The preceding stage learning model 50A is a learning model that performs inference of a preceding stage of a trained learning model. For example, the preceding stage learning model 50A includes layers corresponding to the convolutional layers 20a, 21a, 22a, and 23a and the pooling layers 20b, 21b, 22b, and 23b described with reference to FIG. 11.

The input image data 141 is data of an input image to be inferred. For example, the input image data 141 corresponds to the input image 45 illustrated in FIG. 1.

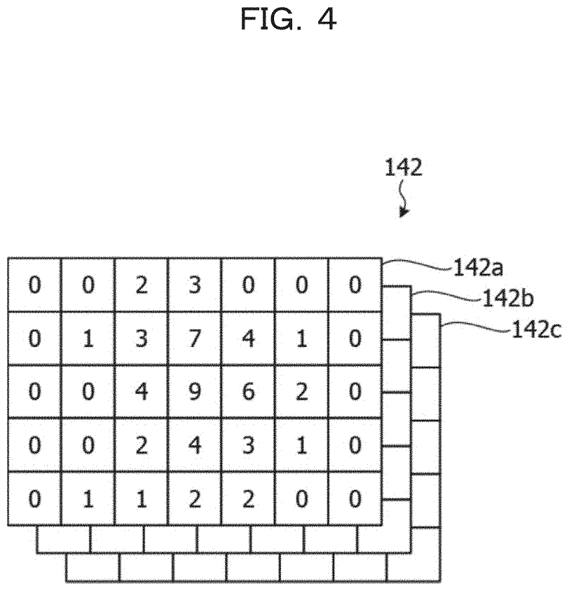

The first feature amount data 142 is a feature map calculated by inputting the input image data 141 to the preceding stage learning model 50A. FIG. 4 is a diagram illustrating an example of the first feature amount data 142. In the example illustrated in FIG. 4, a plurality of feature maps 142a, 142b, and 142c is illustrated. For example, the feature maps are generated for the number of filters used in the convolutional layers of the preceding stage learning model 50A.

The feature map 142a will be described. The feature map 142a is divided into a plurality of areas. It is assumed that each area of the feature map 142a is associated with each area of the input image data 141. A numerical value of the area of the feature map 142a becomes a greater value as a corresponding area of the input image data 141 strongly represents a feature of the image.

For example, on a preceding side of the learning model, an area in which a luminance level changes sharply and an area having a linear boundary line are areas that strongly represent the feature of the image. On a subsequent side of the learning model, areas that correspond to eyes, leaves, wheels, and the like are the areas that strongly represent the feature of the image.

It is assumed that, similarly to the feature map 142a, the feature maps 142b and 142c are divided into a plurality of areas, and each area of the feature maps 142b and 142c is associated with each area of the input image data 141. Other descriptions regarding the feature maps 142b and 142c are similar to those of the feature map 142a.

The corrected image data 143 is data of a corrected image in which an area of interest of the input image data 141 is blackened. For example, the corrected image data 143 corresponds to the corrected image 46 illustrated in FIG. 1.

The second feature amount data 144 is a feature map calculated by inputting the corrected image data 143 to the preceding stage learning model 50A. Similar to the first feature amount data 142, the second feature amount data 144 includes a plurality of feature maps. Furthermore, each feature map is divided into a plurality of areas, and numerical values are set.

The control unit 150 is implemented by a processor such as a central processing unit (CPU) or a micro processing unit (MPU), executing various programs stored in a storage device inside the edge node 100 by using the RAM or the like as a work area. Furthermore, the control unit 150 may be implemented by an integrated circuit (IC) such as an application specific integrated circuit (ASIC) or a field programmable gate array (FPGA). The control unit 150 includes an acquisition unit 151, a correction unit 152, a generation unit 153, and a transmission unit 154.

The acquisition unit 151 acquires the input image data 141 from an external device or the like. The acquisition unit 151 stores the acquired input image data 141 in the storage unit 140. The acquisition unit 151 may acquire the input image data 141 from the input unit 120.

The correction unit 152 generates the corrected image data 143 by identifying an area of interest of the input image data 141 and masking the identified area of interest. Hereinafter, an example of processing of the correction unit 152 will be described.

The correction unit 152 generates the first feature amount data 142 by inputting the input image data 141 to the preceding stage learning model 50A. The first feature amount data 142 includes a plurality of feature maps, as described with reference to FIG. 4. The correction unit 152 selects any one of the feature maps (for example, the feature map 142a), and identifies an area in which a set numerical value is equal to or greater than a threshold, among areas of the selected feature map 142a.

The correction unit 152 identifies, as an area of interest, an area of the input image data 141 that corresponds to the area identified from the feature map. The correction unit 152 generates the corrected image data 143 by masking (blackening) the area of interest of the input image data 141. The correction unit 152 stores the corrected image data 143 in the storage unit 140.

The generation unit 153 generates the second feature amount data 144 by inputting the corrected image data 143 to the preceding stage learning model 50A. The generation unit 153 stores the second feature amount data in the storage unit 140.

The transmission unit 154 transmits the second feature amount data 144 to the cloud 200 via the communication unit 110.

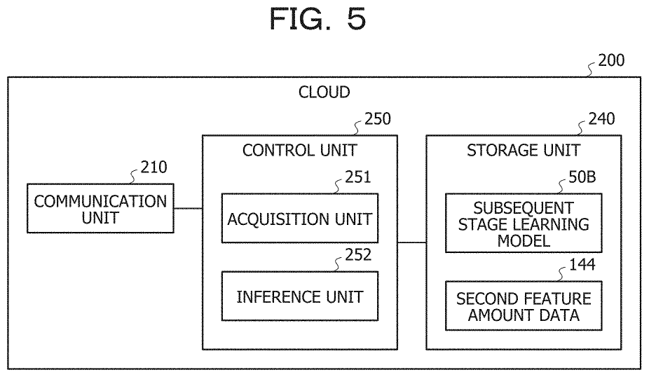

Next, a configuration example of the cloud 200 illustrated in FIG. 1 will be described. FIG. 5 is a diagram illustrating a functional configuration of the cloud 200 according to the present embodiment. As illustrated in FIG. 5, the cloud 200 includes a communication unit 210, a storage unit 240, and a control unit 250.

The communication unit 210 executes data communication with the edge node 100 via the network 6.

The storage unit 240 is a storage device that stores various types of information, and is implemented by, for example, a semiconductor memory element such as a RAM or a flash memory, or a storage device such as a hard disk or an optical disk. The storage unit 240 includes the subsequent stage learning model 50B and the second feature amount data 144.

The subsequent stage learning model 50B includes layers corresponding to the convolutional layers 24a and 25, the pooling layer 24b, and the fully connected layers 26 and 27 described with reference to FIG. 11.

The second feature amount data 144 is information received from the edge node 100. The description regarding the second feature amount data 144 is similar to the description described above.

The control unit 250 is implemented by a processor such as a CPU or an MPU, executing various programs stored in a storage device inside the cloud 200 by using the RAM or the like as a work area. Furthermore, the control unit 250 may be implemented by an IC such as an ASIC or an FPGA. The control unit 250 includes an acquisition unit 251 and an inference unit 252.

The acquisition unit 251 acquires the second feature amount data 144 from the edge node 100 via the communication unit 210. The acquisition unit 251 stores the second feature amount data 144 in the storage unit 240.

The inference unit 252 generates output information by inputting the second feature amount data 144 to the subsequent stage learning model 50B. The output information includes a type, a position, and a score (likelihood) of an object included in the corrected image 46. The inference unit 252 may output the output information to an external device. The inference unit 252 may feed back a score of an inference result included in the output information to the edge node 100.

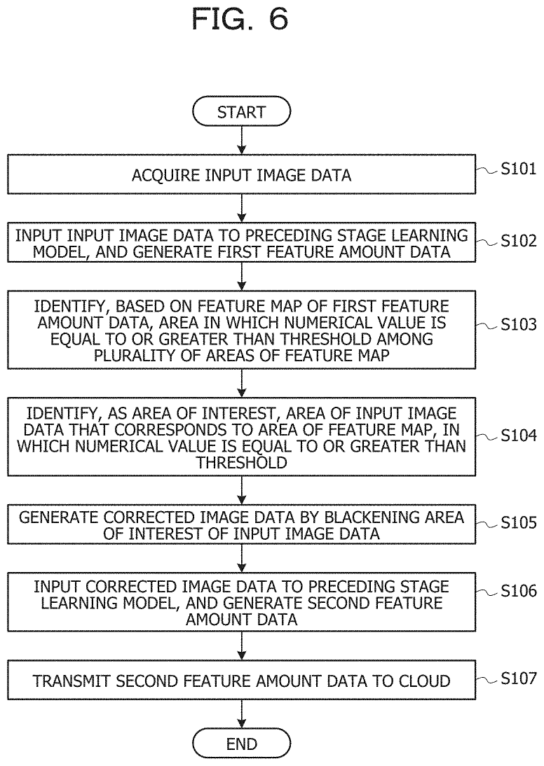

Next, an example of each of processing procedures of the edge node 100 and the cloud 200 of the information processing system according to the present embodiment will be described. FIG. 6 is a flowchart illustrating the processing procedure of the edge node 100 according to the present embodiment. As illustrated in FIG. 6, the acquisition unit 151 of the edge node 100 acquires the input image data 141 (Step S101).

The correction unit 152 of the edge node 100 inputs the input image data 141 to the preceding stage learning model 50A, and generates the first feature amount data 142 (Step S102). The correction unit 152 identifies, based on a feature map of the first feature amount data, an area in which a numerical value is equal to or greater than a threshold among a plurality of areas of the feature map (Step S103).

The correction unit 152 identifies, as an area of interest, an area of the input image data 141 that corresponds to the area of the feature map, in which the numerical value is equal to or greater than the threshold (Step S104). The correction unit 152 generates the corrected image data 143 by blackening the area of interest of the input image data 141 (Step S105).

The generation unit 153 inputs the corrected image data 143 to the preceding stage learning model 50A, and generates the second feature amount data 144 (Step S106). The transmission unit 154 of the edge node 100 transmits the second feature amount data 144 to the cloud 200 (Step S107).

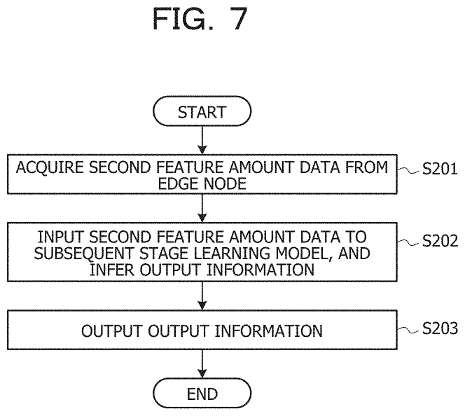

FIG. 7 is a flowchart illustrating the processing procedure of the cloud 200 according to the present embodiment. As illustrated in FIG. 7, the acquisition unit 251 of the cloud 200 acquires the second feature amount data 144 from the edge node 100 (Step S201).

The inference unit 252 of the cloud 200 inputs the second feature amount data 144 to the subsequent stage learning model 50B, and infers output information (Step S202). The inference unit 252 outputs the output information to an external device (Step S203).

Next, an effect of the information processing system according to the present embodiment will be described. In the information processing system according to the present embodiment, in a case where inference of the input image data 141 is performed, the edge node 100 identifies the area of interest of the input image data 141 based on the first feature amount data 142 obtained by inputting the input image data 141 to the preceding stage learning model 50A. The edge node 100 generates the corrected image data 143 by masking the area of interest of the input image data 141, and transmits, to the cloud 200, the second feature amount data 144 obtained by inputting the corrected image data 143 to the preceding stage learning model 50A. The cloud 200 performs inference by inputting the received second feature amount data 144 to the subsequent stage learning model 50B.

For example, since the corrected image data 143 is an image obtained by masking a characteristic portion of the input image data 141, the corrected image data 143 does not include important information in terms of privacy. Therefore, by transmitting the second feature amount data 144 of the corrected image data 143 to the cloud 200, it is possible to maintain the privacy for the characteristic area of the original image.

Furthermore, as described with reference to FIG. 2, even when the second feature amount data 144 of the corrected image data 143 is transmitted to the cloud 200 and inference is executed, the inference may be executed with high accuracy.

Note that, apart from the present embodiment, a method using a face detection model is conceivable as a method of identifying the area of interest of the input image data 141. For example, detecting characteristic portions (eyes, nose, and the like) of an object by inputting the input image data 141 to the face detection model, blackening the detected characteristic portions, and inputting the blackened input image data 141 to the preceding stage learning model 50A. However, using such a method increases a calculation cost because it is assumed that inference is once performed by the entire face detection model. Furthermore, a cost of preparing the face detection model separately is also needed. Thus, it may be said that the information processing system according to the present embodiment is superior to the method using the face detection model.

Meanwhile, the processing of the information processing system described above is an example, and another processing may be executed. Hereinafter, the another processing of the information processing system will be described.

In a case where the area of interest of the input image data 141 is identified, the correction unit 152 of the edge node 100 selects any one feature map included in the first feature amount data 142, and identifies the area in which the set numerical value is equal to or greater than the threshold. However, the present embodiment is not limited to this.

For example, the correction unit 152 may identify the area in which the set numerical value is equal to or greater than the threshold for each feature map included in the first feature amount data 142, and identify, as the area of interest, an area of the input image data 141 corresponding to the identified area of each feature map. In this case, the correction unit 152 may adjust a ratio of the area of interest set in the input image data 141 (a ratio of the area of interest to the entire area) to be less than a predetermined ratio.

Furthermore, the correction unit 152 may acquire a score of an inference result from the cloud 200, and adjust the predetermined ratio described above. For example, in a case where the score of the inference result is less than a predetermined score, the correction unit 152 may perform control to reduce the predetermined ratio described above, thereby reducing an area to be blackened and suppressing the score from being lowered.

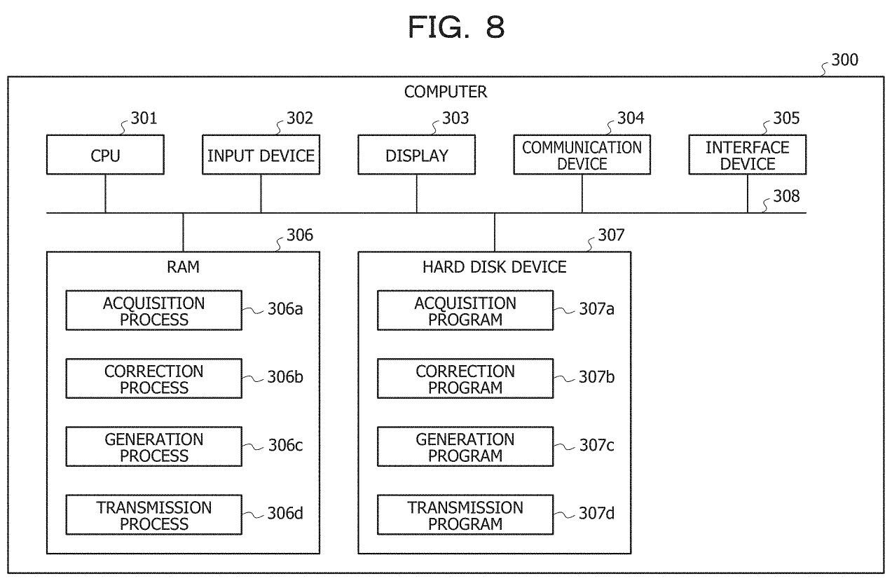

Next, an example of a hardware configuration of a computer that implements functions similar to those of the edge node 100 indicated in the embodiment described above will be described. FIG. 8 is a diagram illustrating an example of the hardware configuration of the computer that implements the functions similar to those of the edge node 100 of the embodiment.

As illustrated in FIG. 8, a computer 300 includes a CPU 301 that executes various types of arithmetic processing, an input device 302 that receives data input from a user, and a display 303. Furthermore, the computer 300 includes a communication device 304 that exchanges data with the cloud 200, an external device, or the like via a wired or wireless network, and an interface device 305. Furthermore, the computer 300 includes a RAM 306 that temporarily stores various types of information, and a hard disk device 307. Each of the devices 301 to 307 is coupled to a bus 308.

The hard disk device 307 includes an acquisition program 307a, a correction program 307b, a generation program 307c, and a transmission program 307d. Furthermore, the CPU 301 reads the individual programs 307a to 307d, and loads them into the RAM 306.

The acquisition program 307a functions as an acquisition process 306a. The correction program 307b functions as a correction process 306b. The generation program 307c functions as a generation process 306c. The transmission program 307d functions as a transmission process 306d.

Processing of the acquisition process 306a corresponds to the processing of the acquisition unit 151. Processing of the correction process 306b corresponds to the processing of the correction unit 152. Processing of the generation process 306c corresponds to the processing of the generation unit 153. Processing of the transmission process 306d corresponds to the processing of the transmission unit 154.

Note that each of the programs 307a to 307d may not necessarily be stored in the hard disk device 307 beforehand. For example, each of the programs is stored in a “portable physical medium” (computer-readable recording medium) to be inserted in the computer 300, such as a flexible disk (FD), a compact disc read only memory (CD-ROM), a digital versatile disc (DVD), a magneto-optical disk, or an integrated circuit (IC) card. Then, the computer 300 may read and execute each of the programs 307a to 307d.

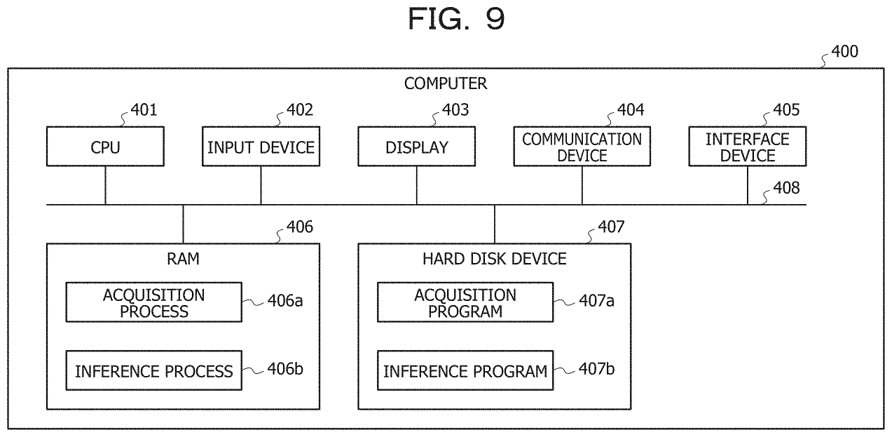

Next, an example of a hardware configuration of a computer that implements functions similar to those of the cloud 200 indicated in the embodiment described above will be described. FIG. 9 is a diagram illustrating an example of the hardware configuration of the computer that implements the functions similar to those of the cloud 200 of the embodiment.

As illustrated in FIG. 9, a computer 400 includes a CPU 401 that executes various types of arithmetic processing, an input device 402 that receives data input from a user, and a display 403. Furthermore, the computer 400 includes a communication device 404 that exchanges data with the edge node 100, an external device, or the like via a wired or wireless network, and an interface device 405. Furthermore, the computer 400 includes a RAM 406 that temporarily stores various types of information, and a hard disk device 407. Each of the devices 401 to 407 is coupled to a bus 408.

The hard disk device 407 includes an acquisition program 407a and an inference program 407b. Furthermore, the CPU 401 reads the individual programs 407a and 407b, and loads them into the RAM 406.

The acquisition program 407a functions as an acquisition process 406a. The inference program 407b functions as an inference process 406b.

Processing of the acquisition process 406a corresponds to the processing of the acquisition unit 251. Processing of the inference process 406b corresponds to the processing of the inference unit 252.

Note that each of the programs 407a and 407b may not necessarily be stored in the hard disk device 407 beforehand. For example, each of the programs is stored in a “portable physical medium” (computer-readable recording medium) to be inserted in the computer 400, such as an FD, a CD-ROM, a DVD, a magneto-optical disk, or an IC card. Then, the computer 400 may read and execute each of the programs 407a and 407b.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system, comprising:
an edge computer that implements a plurality of layers of a preceding stage among a plurality of layers included in a learning model; and
a cloud computer that implements a plurality of layers of a subsequent stage obtained by removing the plurality of layers of the preceding stage from the plurality of layers included in the learning model,
wherein
the edge computer includes:
a first processor configured to:
calculate a first feature amount by inputting a first image to a top layer among the plurality of layers of the preceding stage;
identify an area of interest in the first image based on the first feature amount;
generate a second image obtained by masking the area of interest in the first image;
calculate a second feature amount by inputting the second image to the top layer among the plurality of layers of the preceding stage; and
transmit the second feature amount to the cloud computer, and
the cloud computer includes:
a second processor configured to:
infer an object included in the second image by inputting the second feature amount to a top layer among the plurality of layers of the subsequent stage.

2. The information processing system according to claim 1, wherein
the first feature amount includes a feature map including a plurality of areas for each of which a numerical value that indicates a degree to which a feature of the first image appears is set, and
the first processor is further configured to:
identify, as areas of interest, areas of the first image that correspond to areas of the feature map for which the numerical value equal to or greater than a threshold is set, based on the feature map.

3. The information processing system according to claim 1, wherein
the first processor is further configured to:
execute processing of adjusting a ratio of the areas of interest to an entire area of the first image to be less than a predetermined ratio.

4. An inference method, comprising:
calculating, by a first computer, a first feature amount by inputting a first image to a top layer among the plurality of layers of the preceding stage;
identifying, by the first computer, an area of interest in the first image based on the first feature amount;
generating, by the first computer, a second image obtained by masking the area of interest in the first image;
calculating, by the first computer, a second feature amount by inputting the second image to the top layer among the plurality of layers of the preceding stage;
transmitting, by the first computer, the second feature amount to the cloud computer; and
inferring, by a second computer different from the first computer, an object included in the second image by inputting the second feature amount to a top layer among the plurality of layers of the subsequent stage.

5. The inference method according to claim 4, wherein
the first feature amount includes a feature map including a plurality of areas for each of which a numerical value that indicates a degree to which a feature of the first image appears is set, and
the method further comprises:
identifying by the first computer, as areas of interest, areas of the first image that correspond to areas of the feature map for which the numerical value equal to or greater than a threshold is set, based on the feature map.

6. The inference method according to claim 4, further comprising:
executing, by the first computer, processing of adjusting a ratio of the areas of interest to an entire area of the first image to be less than a predetermined ratio.

7. A non-transitory computer-readable recording medium storing a program for causing a first computer and a second computer different from the first computer to execute a process, the process comprising:
calculating, by the first computer, a first feature amount by inputting a first image to a top layer among the plurality of layers of the preceding stage;
identifying, by the first computer, an area of interest in the first image based on the first feature amount;
generating, by the first computer, a second image obtained by masking the area of interest in the first image;
calculating, by the first computer, a second feature amount by inputting the second image to the top layer among the plurality of layers of the preceding stage;
transmitting, by the first computer, the second feature amount to the cloud computer; and
inferring, by the second computer, an object included in the second image by inputting the second feature amount to a top layer among the plurality of layers of the subsequent stage.

8. The non-transitory computer-readable recording medium according to claim 7, wherein
the first feature amount includes a feature map including a plurality of areas for each of which a numerical value that indicates a degree to which a feature of the first image appears is set, and
the process further comprises:
identifying by the first computer, as areas of interest, areas of the first image that correspond to areas of the feature map for which the numerical value equal to or greater than a threshold is set, based on the feature map.

9. The non-transitory computer-readable recording medium according to claim 7, the process further comprising:
executing, by the first computer, processing of adjusting a ratio of the areas of interest to an entire area of the first image to be less than a predetermined ratio.
